(19) United States
(12) Patent Application Publication
(10) Pub. No.: US 2015/0136014 A1
(43) Pub. Date: May 21, 2015

(54) DEVICES, KITS AND SYSTEMS FOR ENHANCING DISTANCE DETERMINATION IN A TERRAIN

(71) Applicant: Mark PERUZZARO, San Mateo, CA (US)

(72) Inventor: Mark PERUZZARO, San Mateo, CA (US)

(21) Appl. No.: 14/547,446

(22) Filed: Nov. 19, 2014

Related U.S. Application Data
(60) Provisional application No. 61/905,987, filed on Nov. 19, 2013.

(51) Int. Cl. G01C 3/02

(52) U.S. Cl. CPC G01C 3/02
USPC 116/201; 116/209

(57) ABSTRACT

Disclosed are devices, kits and systems for enhancing distance determination of an object from a point of reference within a terrain. One or more devices are provided which are visually distinct in appearance. The devices are placed within a terrain such that devices of a similar visual appearance are at a first distance from the point of reference, objects of a similar appearance different than the first set of objects are placed at a second distance from the point of reference, and so on. The use of one or more devices representing one or more distances from a point of reference can be used to determine a position of one or more items within the terrain based on its position relative to the devices.

### CROSS-REFERENCE

This application claims the benefit of U.S. Provisional Application No. 61/905,987, filed Nov. 19, 2014 entitled Devices, Kits and Systems for Enhancing Distance Determination in Sporting Activities by Peruzzaro, which application is incorporated herein by reference.

### BACKGROUND

There are many situations where determining distance in a terrain is useful. For example, many sports rely on the skill of the sportsman to determine distance. For example, hunting or target practice requires that the person accurately shoot a gun or an arrow at a target that is a distance away which takes into account the trajectory of the projectile which is a function of the distance between the person and the target. Some sports use a site to assist in accurately shooting the target. However, some appreciation of the distance between the person or a reference point and the target is still required. Thus, it would be useful to have assistance in determining relative distance—particularly in outdoor settings.

In the golfing context, U.S. Pat. No. 4,880,232 A to Lang for Flag Pin Golf Ball Distance Measurement Devices issued Nov. 14, 1989, discloses a flag pin golf ball distance measuring device which enables measuring the distance of a golf ball from a hole on a putting green. U.S. Pat. No. 7,412,772 B1 to Khoshnood for Archery Bow Sight issued Aug. 19, 2008, is directed to an archery bow sight, which would be suitable for use with the markers disclosed herein. In other applications, such as crime scene investigation, having perspective of the distance of various components relative to one or more points of reference can also be useful.

### SUMMARY

Markers which are configurable to provide a visual indication that correspond to a distance are provided which facilitate determination of distance of a target, or a plurality of items in a terrain, from a user. In at least some configurations, markers, which can be in the form of coded flags are manufacturable from a material which does not have a scent associated with it. In some configurations, the marker can be manufactured from a material which can emit a scent, or can have a feature which has absorbent qualities which facilitate application of an attractive scent. Markers can be sold individually or as kits wherein kits include more than one marker which are the same, or one or more markers which have varying visual characteristics for use in determining different distances from a target when placed. Additional components of kits can include one or more of an adhesive absorbent material and a pheromone to apply to the absorbent material.

An aspect of the disclosure is directed to a system for distance determination in a terrain. The system comprises: one or more of a first marker having a first elongated member with a first elongated member first end and a first elongated member second end and a first distance determiner positioned at or near either the first elongated member first end or the first elongated member second end wherein the first distance determiner comprises at least one of a first shape, a first color, or a first pattern; and one or more of a second marker having a second elongated member with a second elongated member first end and a second elongated member second end and a second distance determiner positioned at or near either the second elongated member first end or the second elongated member second end wherein the second distance determiner comprises at least one of a second shape, a second color, or a second pattern; wherein the at least one of the first shape, the first color, or the first pattern are distinguishable from the at least one of the second shape, the second color, or the second pattern. Additionally, in at least some configurations, at least one of the first marker or the second marker comprises an absorbent feature wherein the absorbent feature is at least one of integrally formed with the marker or adhered to the marker. For example, the absorbent feature can be integrally formed with the at least one of the first marker or the second marker. In at least some configurations, the system further comprises one or more of a third marker having a third elongated member with a third elongated member first end and a third elongated member second end and a third distance determiner positioned at or near either the third elongated member first end or the third elongated member second end wherein the third distance determiner comprises at least one of a third shape, a third color, or a third pattern. Suitable shapes are selected from a group comprising square, circle, rectangle, ovoid, pentagon, hexagon, pyramidal, sphere, torus, cylinder, cone, cube, and cuboid. The elongated member can be made from one or more of wire, metal, wood, and plastic. Additionally, the distance determiner is made from one or more of wire, metal, wood, plastic, cloth, and leather.

Another aspect of the disclosure is directed to a kit for distance determination in a terrain. A suitable kit comprises: one or more of a first marker having a first elongated member with a first elongated member first end and a first elongated member second end and a first distance determiner positioned at or near either the first elongated member first end or the first elongated member second end wherein the first distance determiner comprises at least one of a first shape, a first color, or a first pattern; and one or more of a second marker having a second elongated member with a second elongated member first end and a second elongated member second end and a second distance determiner positioned at or near either the second elongated member first end or the second elongated member second end wherein the second distance determiner comprises at least one of a second shape, a second color, or a second pattern; wherein the at least one of the first shape, the first color, or the first pattern are distinguishable from the at least one of the second shape, the second color, or the second pattern. Additionally, the kit can further comprise one or more absorbent features. In at least some configurations of the kit, the kit further includes one or more of a third marker having a third elongated member with a third elongated member first end and a third elongated member second end and a third distance determiner positioned at or near either the third elongated member first end or the third elongated member second end wherein the third distance determiner comprises at least one of a third shape, a third color, or a third pattern. Additionally, one or more containers of one or more scents and pheromones can be included in the kit.

Still another aspect of the disclosure is directed to a system for distance determination in a terrain comprising: a first means for marking having a first elongated member with a first elongated member first end and a first elongated member second end and a first means for distance determination positioned at or near either the first elongated member first end or the first elongated member second end wherein the first means for distance determination comprises at least one of a first shape, a first color, or a first pattern; and a second means for marking having a second elongated member with a second elongated member first end and a second elongated member second end and a second means for distance determination positioned at or near either the second elongated member first end or the second elongated member second end wherein the second means for distance determination comprises at least one of a second shape, a second color, or a second pattern; wherein the at least one of the first shape, the first color, or the first pattern are distinguishable from the at least one of the second shape, the second color, or the second pattern. In some configurations, at least one of the first means for marking or the second means for marking comprises a means for absorbing. Additionally, the means for absorbing can be integrally formed with the at least one of the first means for marking or the second means for marking. At least some configurations of the kit can comprise a third means for marking having a third elongated member with a third elongated member first end and a third elongated member second end and a third means for distance determination positioned at or near either the third elongated member first end or the third elongated member second end wherein the third means for distance determination comprises at least one of a third shape, a third color, or a third pattern. Suitable shapes for the distance determination means are selected from a group comprising square, circle, rectangle, ovoid, pentagon, hexagon, pyramidal, sphere, torus, cylinder, cone, cube, and cuboid.

Still another aspect of the disclosure is directed to a method of determining one or more distances in a terrain. Suitable methods comprise the steps of: selecting a reference location in the terrain; placing one or more of a first marker having a first elongated member with a first elongated member first end and a first elongated member second end and a first distance determiner positioned at or near either the first elongated member first end or the first elongated member second end wherein the first distance determiner comprises at least one of a first shape, a first color, or a first pattern at one or more locations a first distance from the reference location; and placing one or more of a second marker having a second elongated member with a second elongated member first end and a second elongated member second end and a second distance determiner positioned at or near either the second elongated member first end or the second elongated member second end wherein the second distance determiner comprises at least one of a second shape, a second color, or a second pattern at one or more locations a second distance from the reference location, wherein the first distance from the reference location is different than the second distance from the reference location. Additionally, the step can further comprise the step of: determining a distance of an object in the terrain by referencing a position of the object relative to a position one or more of each of a first marker and a second marker.

### INCORPORATION BY REFERENCE

All publications, patents, and patent applications mentioned in this specification are herein incorporated by reference to the same extent as if each individual publication, patent, or patent application was specifically and individually indicated to be incorporated by reference. Other references of note are: U.S. Pat. No. 7,441,365 B2 to Brunner et al. for Deer Attracting Apparatus issued Oct. 28, 2008; U.S. Pat. No. 8,006,394 B2 to Tippett et al. for Apparatus, Method and System for Precise Identification of Multiple Points Distributed Throughout an Area issued Aug. 30, 2011; and U.S. Pat. No. 8,087,195 B2 to Minges for Tree Mounted Apparatus issued Jan. 3, 2012.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A illustrates a marker; FIG. 1B illustrates a marker with an adsorbent feature thereon;

FIG. 2 illustrates a set of markers which are visually distinguishable;

FIG. 3 illustrates use of markers to facilitate distance determination from a point; and

FIGS. 4-6 illustrate various uses of placing markers relative to a blind, stand, animal trail, and the like.

### DETAILED DESCRIPTION

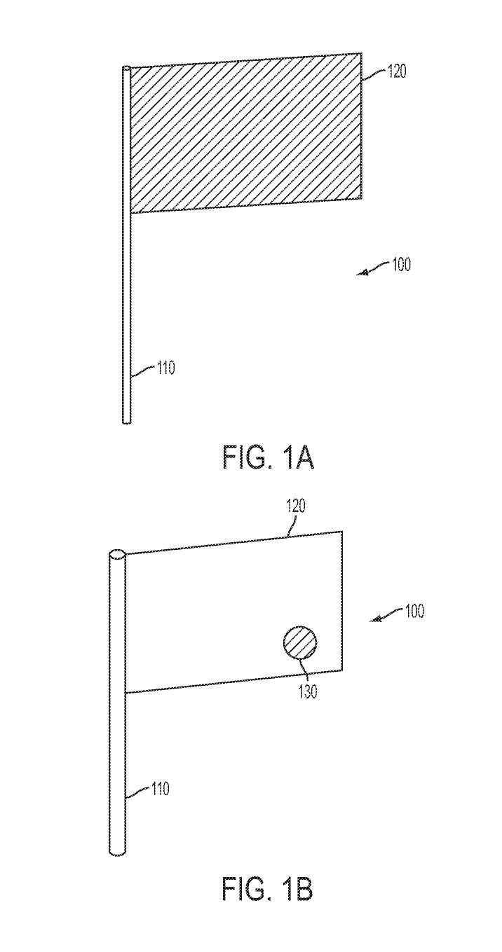

FIG. 1A illustrates a marker 100 which has an elongated member 110 such as a staff or cord, and a distance determiner 120, such as a flag or a piece of material, attached or appended to the elongated member 110. The elongated member 110 has a first end and a second end and can be formed from any suitable material including, but not limited to, wire, metal, wood, and plastic. Additionally, the elongated member can be coated with a material (e.g., metal coated with plastic). Wire can include materials that are composed of more than one piece of material. The distance determiner 120 can similarly be formed of any suitable material, such as plastic or fabric. In some configurations, the marker can be an extension of the elongated member and rigid in shape. Additionally, the marker can take on any suitable shape desired including, but not limited to, square, circle, rectangle, ovoid, pentagon, and hexagon. Three dimensional shapes, such as, pyramidal, sphere, torus, cylinder, cone, cube, and cuboid, can also be used without departing from the scope of the disclosure. The distance determiner 120 can be integrally formed with the elongated member 110. Thus, for example, the marker 100 can be one piece or can be configured to act in a unified manner.

For illustration purposes FIG. 1A illustrates the distance determiner 120 with a rectangular shape. As shown in FIG. 1B illustrates a marker 100 with an absorbent feature 130 thereon. The absorbent feature 130 can be any desired shape (square, circular, rectangular, ovoid, etc.) and can be made from any suitable material, e.g., felt. Moreover, the absorbent feature 130 can be adhered to the distance determiner or to the marker at any location using, for example, any suitable adhesive material or can be formed integrally with the marker during a manufacturing process. Markers can be one or more of each of: differing in color, differing in shape, differing in application of a designator (e.g., a numeric distance designator, an alpha designator, etc.).

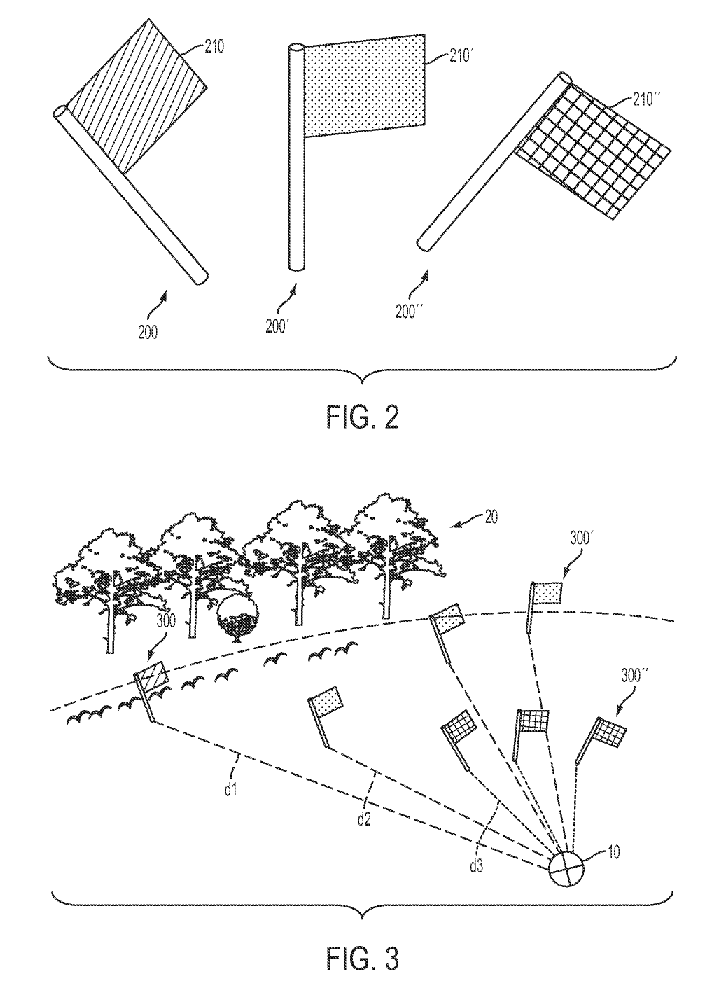

FIG. 2 illustrates a set of markers 200, 200′, 200″ which are visually distinguishable; e.g, via shape, color, marker. As illustrated, the first marker 200 has a distance determiner 210 with a lined pattern in a first direction, the second marker 200′ has a distance determiner 210′ with a dotted pattern, and the third marker 200″ has a distance determiner 210″ with a cross-hatch pattern. In practice, the markers can be distinguishable by the use of one or more of patterns, colors, shapes, and/or markings. Thus, in one configuration, a first marker could use a rectangular flag, while a second marker uses a triangular flag, and a third marker uses a round flag. In another configuration, the first marker could use a red flag, the second marker could use a yellow flag, and the third marker could use a blue flag. In still other configurations, combinations of shape, pattern and color can be used to provide greater visual distinction between markers. The use of visually distinguishable patterns, markings, colors, and the like facilitates the user of each particular visual distinguishable feature to denote a corresponding distance or yardage from a point of reference.

FIG. 3 illustrates use of markers to facilitate distance determination from a point of reference. Markers 300, 300′, 300″ are placed, for example in a clearing in the woods, such that markers having the same pattern, color, or shape are the same distance away from a point 10, e.g. a blind where a hunter might be positioned. Thus, as illustrated here, a first set of markers 300, is a distance d1 from a point, a second set of markers 300′, visually distinct from the first set of markers 300, is second distance d2 from a point, and a third set of markers 300″, visually distinct from both the first set of markers 300 and the second set of markers 300′ is a third distance d3 from a point 10. Typically, the distances from the point represented by each of the markers is known and selected by the person placing the markers. For example, d1 could be a distance 500 feet from a point 10, while d2 is a distance 300 feet from a point, etc. The positioning of visually distinctive markers distances from a point is typically chosen by a user. Moreover, the distances and, for example, colors of the markers can correspond with the colors in a site associated with, for example, a bow. The distance associated with each marker can be determined by, for example, using a range finder. In one embodiment, a color flag can correspond to a numeric distance displayed in the range finder and/or correspond to a side pin of a bow or similar device. In another configuration, the adhesive pads used for scent applications can be color coded to correspond to a numeric distance as well.

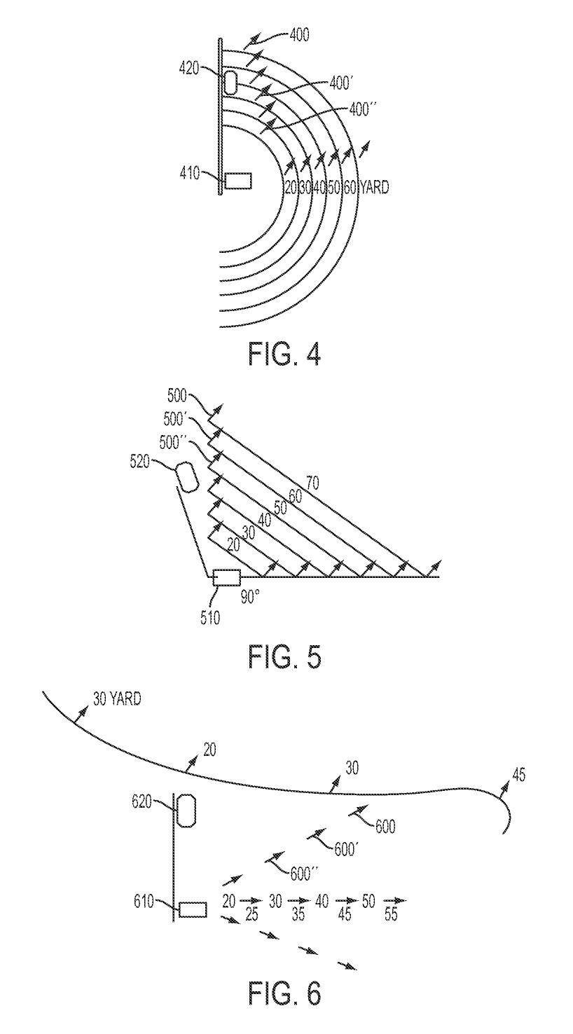

As shown in FIGS. 4-6, as a user approaches, for example, a ground blind 410, 510, 610, or tree stand 420, 520, 620, the user can range the distance from the blind or stand by placing markers 400, 400′, 400″, 500, 500′, 500″, 600, 600′, 600″ at distances from the blind or stand. In this figure markers are placed at 20, 30, 40, 50, and 60 yards. Other distances can be selected without departing from the scope of the disclosure.

In one aspect, a user determines the distance from a desired point using, for example a siting device. The user then places a marker in the location corresponding to a desired distance. All markers placed at a first distance have the same marking features (e.g., size, color, etc.). Each time a marker is placed, the user determines the distance and selects a corresponding distinct marker to represent that distance.

In another aspect, a first user is at the desired point from which the markers will be measured. As a second user is positioned within, for example, the field, the first user uses a citing device to determine the distance between the two users. When the second user is at a desired distance and location, the first user coordinates the placement of an appropriate marker representing the distance at the desired location.

In use, in the hunting context, for a bow hunter the pre-placement of coded markers enables the bow hunter to take a shot at the desired target without the need for the interim step of determining distance—which interim step could lead to the target becoming aware of the hunter's positioning and moving before the hunter could take a shot.

### Uses of Devices and Systems

tracking
   a. tracking blood trail
   b. tracking foot prints /direction of travel, marker
distance
   a. yardage/feet marker
   b. range/distance needed for any all applications of use
   c. set out in any pattern depending on use of land, water, species
Adhesive pad natural or man-made material
   a. luring of animal
   b. any and all commercial scents luring applications
flag color for the entire color spectrum
   a. corresponds with bow/an or any site/ pins for bow site example red 10 yard green 20 yard, etc.
   b. distance marker for any distance application sport or hunting
path finding device
   a. colored/reflective
trial marker
   a. colored/reflective
use for distance
   a. big game, water fowl, bow hunting, gun use, fishing, all applications for distance

### Material

stakes
   a. natural and/or man-made materials which can, for example, be edible (e.g., fruit roll-up, etc.), biodegradable, wood, metal, fiberglass or combinations thereof
flag
   a. synthetic and or natural materials
coloring
   a. color spectrum
   b. customized color applications
   c. reflective
numeric and or alpha numeric for distance
customized logo for all applications
scent pads
   a. all colors, adhesive, pad/sponge to take any all scent

Kits of markers would include one or more markers having a first flag visual configuration, one or more markers having a second flag visual configuration, with or without an absorbent material. For kits having markers that do not have an absorbent material associated with them, kits could also include an absorbent material with an adhesive surface for adhering to the flags. The absorbent material can also be color coded, if desired. Additional components include one or more of additional flags with additional visual configurations. Still other components include scented material for applying to the absorbent material, such as pheromones, doe estrus, and the like.

As will be appreciated by those skilled in the art, the application for the devices, methods and kits disclosed includes tracking (e.g., tracking a blood trail, tracking footprints, tracking direction of travel); distance marking (e.g., yardage/foot marker, range/distance marker, distance determiner). The adhesive pads can be used for luring an animal using, for example, any commercial scent available. Suitable scents or pheromones include, for example, Doc's Dominant Buck Urine™, Doc's Extreme Heat Urine™, Doc's Double Doe Urine™ available from Doc's Deer Farm and Scent, LLC; Doe in Heat Shot Scent and Deer Hunting Attractant™ available from Nuzzi Outdoors; Red Fox, Code Blue, Code Red, and Tink 69. Other scents, for example, plant based scents such as corn or apple can also be used. The distance determiner can provide a distance marker for any distance application including, but not limited to, sports, hunting, crime scene investigation, etc. The distance determiner can be colored, reflective, patterned, printed, etc.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A system for distance determination in a terrain comprising:
one or more of a first marker having a first elongated member with a first elongated member first end and a first elongated member second end and a first distance determiner positioned at or near either the first elongated member first end or the first elongated member second end wherein the first distance determiner comprises at least one of a first shape, a first color, or a first pattern; and
one or more of a second marker having a second elongated member with a second elongated member first end and a second elongated member second end and a second distance determiner positioned at or near either the second elongated member first end or the second elongated member second end wherein the second distance determiner comprises at least one of a second shape, a second color, or a second pattern;
wherein the at least one of the first shape, the first color, or the first pattern are distinguishable from the at least one of the second shape, the second color, or the second pattern.

2. The system of claim 1 wherein at least one of the first marker or the second marker comprises an absorbent feature wherein the absorbent feature is at least one of integrally formed with the marker or adhered to the marker.

3. The system of claim 2 wherein the absorbent feature is integrally formed with the at least one of the first marker or the second marker.

4. The system of claim 1 further comprising one or more of a third marker having a third elongated member with a third elongated member first end and a third elongated member second end and a third distance determiner positioned at or near either the third elongated member first end or the third elongated member second end wherein the third distance determiner comprises at least one of a third shape, a third color, or a third pattern.

5. The system of claim 1 wherein the shape is selected from a group comprising square, circle, rectangle, ovoid, pentagon, hexagon, pyramidal, sphere, torus, cylinder, cone, cube, and cuboid.

6. The system of claim 1 wherein the elongated member is made from one or more of wire, metal, wood, and plastic.

7. The system of claim 1 wherein the distance determiner is made from one or more of wire, metal, wood, plastic, cloth, and leather.

8. A kit for distance determination in a terrain comprising:
one or more of a first marker having a first elongated member with a first elongated member first end and a first elongated member second end and a first distance determiner positioned at or near either the first elongated member first end or the first elongated member second end wherein the first distance determiner comprises at least one of a first shape, a first color, or a first pattern; and
one or more of a second marker having a second elongated member with a second elongated member first end and a second elongated member second end and a second distance determiner positioned at or near either the second elongated member first end or the second elongated member second end wherein the second distance determiner comprises at least one of a second shape, a second color, or a second pattern;
wherein the at least one of the first shape, the first color, or the first pattern are distinguishable from the at least one of the second shape, the second color, or the second pattern.

9. The kit of claim 8 further comprising one or more absorbent feature.

10. The kit of claim 8 further comprising one or more of a third marker having a third elongated member with a third elongated member first end and a third elongated member second end and a third distance determiner positioned at or near either the third elongated member first end or the third elongated member second end wherein the third distance determiner comprises at least one of a third shape, a third color, or a third pattern.

11. The kit of claim 8 further comprising one or more containers of one or more scents and pheromones.

12. A system for distance determination in a terrain comprising:
a first means for marking having a first elongated member with a first elongated member first end and a first elongated member second end and a first means for distance determination positioned at or near either the first elongated member first end or the first elongated member second end wherein the first means for distance determination comprises at least one of a first shape, a first color, or a first pattern; and
a second means for marking having a second elongated member with a second elongated member first end and a second elongated member second end and a second means for distance determination positioned at or near either the second elongated member first end or the second elongated member second end wherein the second means for distance determination comprises at least one of a second shape, a second color, or a second pattern;
wherein the at least one of the first shape, the first color, or the first pattern are distinguishable from the at least one of the second shape, the second color, or the second pattern.

13. The system of claim 12 wherein at least one of the first means for marking or the second means for marking comprises a means for absorbing.

14. The system of claim 13 wherein the means for absorbing is integrally formed with the at least one of the first means for marking or the second means for marking.

15. The system of claim 12 further comprising a third means for marking having a third elongated member with a third elongated member first end and a third elongated member second end and a third means for distance determination positioned at or near either the third elongated member first end or the third elongated member second end wherein the third means for distance determination comprises at least one of a third shape, a third color, or a third pattern.

16. The system of claim 12 wherein the shape is selected from a group comprising square, circle, rectangle, ovoid, pentagon, hexagon, pyramidal, sphere, torus, cylinder, cone, cube, and cuboid.

17. A method of determining one or more distances in a terrain comprising the steps of:
selecting a reference location in the terrain;
placing one or more of a first marker having a first elongated member with a first elongated member first end and a first elongated member second end and a first distance determiner positioned at or near either the first elongated member first end or the first elongated member second end wherein the first distance determiner comprises at least one of a first shape, a first color, or a first pattern at one or more locations a first distance from the reference location; and
placing one or more of a second marker having a second elongated member with a second elongated member first end and a second elongated member second end and a second distance determiner positioned at or near either the second elongated member first end or the second elongated member second end wherein the second distance determiner comprises at least one of a second shape, a second color, or a second pattern at one or more locations a second distance from the reference location, wherein the first distance from the reference location is different than the second distance from the reference location.

18. A method of determining one or more distances in a terrain further comprising the step of:
determining a distance of an object in the terrain by referencing a position of the object relative to a position one or more of each of a first marker and a second marker.
